(19) United States
(12) Patent Application Publication
(10) Pub. No.: US 2012/0263854 A1
(43) Pub. Date: Oct. 18, 2012

(54) FLAT BREAD DOUGH COMPOSITION AND METHOD FOR MAKING FLAT BREADS

(75) Inventors: LISA CHEDID, KENDALL PARK, NJ (US); JOHN TOCZEK, SOMERSET, NJ (US); JOHN BRODIE, PENNDEL, PA (US)

(73) Assignee: INNOPHOS, INC., CRANBURY, NJ (US)

(21) Appl. No.: 13/007,521

(22) Filed: Jan. 14, 2011

Related U.S. Application Data
(63) Continuation-in-part of application No. 10/456,928, filed on Jun. 6, 2003, now abandoned.
(60) Provisional application No. 60/386,785, filed on Jun. 7, 2002.

(51) Int. Cl. A21D 2/02; A21D 8/02

(52) U.S. Cl. 426/551; 426/503; 426/502

(57) ABSTRACT

The present invention relates to a flat bread dough composition, comprising: A) flour; B) shortening; C) water; and D) a leavening system having a leavening base and a leavening acid having a combination selected from the group consisting of a) sodium aluminum phosphate and dicalcium phosphate dihydrate; b) sodium aluminum phosphate and sodium acid pyrophosphate; c) sodium acid pyrophosphate and dicalcium phosphate dihydrate; d) sodium acid pyrophosphate, monocalcium phosphate, and calcium acid pyrophosphate; e) dicalcium phosphate dehydrate, monocalcium phosphate, and calcium acid pyrophosphate; f) sodium aluminum phosphate, sodium acid pyrophosphate, and dicalcium phosphate dihydrate; g) sodium aluminum sulfate and dicalcium phosphate dihydrate; and h) sodium aluminum sulfate and sodium acid pyrophosphate, the sodium acid pyrophosphate exhibiting an evolved percentage of carbon dioxide of about 30 or less at room temperature prior to baking, and the slower reacting of the leavening acids in the combination being at least 10 wt % of the total weight of the acid combination.

### CROSS REFERENCE TO RELATED APPLICATIONS

The present continuation-in-part application claims priority from U.S. Utility application Ser. No. 10/456,928, filed Jun. 6, 2003 and U.S. Provisional Application Serial No. 60/386,785, filed Jun. 7, 2002.

### BACKGROUND OF THE INVENTION

1. Field of the Invention

The present invention relates to a dough composition having a delayed or attenuated leavening profile for making flatbreads. The present invention still further relates to methods for making flatbreads.

2. Description of the Prior Art

Flat breads are manufactured commercially by forming a dough, flattening the dough to form dough flats, and baking the flats until they leaven and ultimately set. Representative manufacturing processes include pressing, die cutting and hand stretching. The dough typically comprises flour, a leavening system, shortening, and water. The leavening system comprises a leavening base, e.g. sodium bicarbonate, and one or more leavening acids. The leavening base and leavening acid(s) react to yield carbon dioxide (neutralization reaction), which, along with any other gases present, leaven the dough.

The composition of the leavening system may vary depending upon the desired leavening profile. The leavening profile is usually regulated by selection of type and amount of leavening acid(s). Leavening acids may exhibit varying reaction rates and activation temperatures. Examples of leavening acids are sodium aluminum phosphate (SALP), sodium acid pyrophosphate (SAPP), calcium acid pyrophosphate (CAPP), dicalcium phosphate dihydrate (DCPD), monocalcium phosphate (anhydrous and monohydrate)(MCP), sodium aluminum sulfate (SAS), and organic acids such citric acid and fumaric acid.

A problem in manufacturing flatbreads is a premature leavening profile. For example, flatbreads are generally prepared by forming a dough, flattening the dough to form dough flats and baking the flats until they leaven and set. A number of manufacturing methods are employed commercially. The methods include pressing, die cutting and hand stretching. Manufacturers also typically use dough formulations employing a leavening system having a leavening base of sodium bicarbonate and a leavening acid of monocalcium phosphate (MCP), sodium aluminum phosphate (SALP), sodium aluminum sulfate (SAS) or sodium acid pyrophosphate (SAPP). When such dough formulations are baked, the dough formulations exhaust their leavening gases and begin to lose their leavening (begin to collapse) prematurely. A premature leavening profile may negatively impact cell structure, opacity, pliability, appearance, texture and eating quality in flatbreads. Manufacturers usually make up for what is lost due to premature leavening profile by increasing the level of leavening agents by as much as 15 wt % based on flour weight.

Those skilled in the art have worked to solve the problem of premature leavening in flatbreads. For example, U.S. Pat. No. 6,149,960 at col 5, lines 15-24, discloses the importance of order of addition of the leavening agents. Specifically, the order of addition of the components must be such that the carbonate factor must not be added to the mix at the beginning with other dry ingredients. Further, col 6, lines 57 -65 state that any convenient heat activated leavening acid can be used, for example, SALP, sodium aluminum sulfate, dimagnesium phosphate, dicalcium phosphate dihydrate, encapsulated acids and mixtures thereof. Col 7, lines 60-67 discloses the amount of leavening acid required, as “ the amount theoretically necessary to neutralize from about 30 wt % to 65% of the carbonate factor.

2010/0086639 relates to a microwaveable dough. In particular, paragraphs [0008], [0009], and [0042] disclose the utility of the invention in flatbreads. Paragraph [0014] describes the useful leavening agents: yeast, sodium bicarbonate, ammonium bicarbonate, encapsulated calcium bicarbonate; leavening acids such as sodium aluminum phosphate, monocalcium phosphate anhydrous or monohydrate, sodium acid pyrophosphate, sodium aluminum sulfate, monopotassium tartrate, dicalcium phosphate dihydrate, and mixtures thereof. Para [0014 ] states that a preferred composition is compressed yeast, encapsulated sodium bicarbonate, and sodium aluminium phosphate.

The present invention distinguishes itself from the current state of the art because yeast, with its longer leavening profile, is not required as in 2020/0086639. Further, the order of addition of the carbonate factor (the base) is not important to achieving the appropriate leavening profile as it is in U.S. Pat. No. 6,149,960.

### SUMMARY OF THE INVENTION

The present invention relates to a flat bread dough composition, comprising: A) flour; B) shortening; C) water; and D) a leavening system having a leavening base and a leavening acid having a combination selected from the group consisting of a) sodium aluminum phosphate and dicalcium phosphate dihydrate; b) sodium aluminum phosphate and sodium acid pyrophosphate; c) sodium acid pyrophosphate and dicalcium phosphate dihydrate; d) sodium acid pyrophosphate, monocalcium phosphate, and calcium acid pyrophosphate; e) dicalcium phosphate dehydrate, monocalcium phosphate, and calcium acid pyrophosphate; f) sodium aluminum phosphate, sodium acid pyrophosphate, and dicalcium phosphate dihydrate; g) sodium aluminum sulfate and dicalcium phosphate dihydrate; and h) sodium aluminum sulfate and sodium acid pyrophosphate, the sodium acid pyrophosphate exhibiting an evolved percentage of carbon dioxide of about 30 or less at room temperature prior to baking, and the slower reacting of the leavening acids in the combination being at least 10 wt % of the total weight of the acid combination.

In any combination, the slower or slowest reacting of the acids comprises at least 10 wt %, preferably at least 15 wt % and most preferably about 15 wt % to about 40 wt % of the total weight of the acid combination. A preferred leavening acid has a neutralizing value of about 40 to about 65. It is particularly desirable to have a sodium acid pyrophosphate that exhibits an evolved percentage of carbon dioxide of about 30 or less and preferably about 20 or less at room temperature prior to baking (i.e during the mixing and forming stage.

Further according to the present invention, there is a method for making flatbreads. The method has the steps of providing the dough composition described above, allowing the dough to relax, dividing and rounding the dough composition to form a plurality of discrete dough balls, allowing the dough balls to relax, pressing the relaxed dough balls under heat and pressure to form relatively thinner dough flats, and baking the dough flats to form the flatbreads.

Further according to the present invention, there is a method for making flatbreads. The method has the following steps: a) providing a dough composition; b) allowing the dough composition to relax; c) flattening the relaxed dough composition to form relatively thinner dough flats; and d) baking the dough flats to form the flatbreads.

Further according to the present invention, there is a method for making flatbreads. The method has the following steps: a) providing a dough composition; b) allowing the dough composition to relax; c) dividing and rounding the relaxed dough composition to form a plurality of discrete dough balls, d) freezing the dough balls, e) thawing the dough balls to a higher temperature, f) flattening the dough balls to form relatively thinner dough flats and g) baking the dough flats to form flatbreads.

Further according to the present invention, there is a method for making flatbreads. The method has the following steps: a) providing a dough composition; b) allowing the dough composition to relax; c) rolling the dough to form a sheet; d) cutting the dough to form discrete dough flats and e) baking the dough flats to form the flatbreads.

Further according to the present invention, there is a method for making flatbreads. The method has the following steps: a) providing a dough composition; b) allowing the dough composition to relax; c) dividing and rounding the dough composition to form a plurality of discrete dough balls; d) allowing the dough balls to relax; e) rolling the relaxed dough balls to form relatively thinner dough flats; f) reshaping the periphery of the dough fiats; and f) baking the reshaped dough flats to form the flatbreads.

Further according to the present invention, there is a flatbread dough composition having flour, shortening, water, and leavening system having DCPD as a leavening acid.

### DEFINITIONS AND USAGES OF TERMS

The term “flatbread”, as used herein, means a relatively thin bread product, typically, less than 2 inches thick. Examples of flat breads include, but are not limited to, tortillas, roti, naan, foccacia, pita bread and pizza crust.

### DETAILED DESCRIPTION OF THE INVENTION

The present invention relates to a flat bread dough composition, comprising: A) flour; B) shortening; C) water; and D) a leavening system having a leavening base and a leavening acid having a combination selected from the group consisting of a) sodium aluminum phosphate and dicalcium phosphate dihydrate; b) sodium aluminum phosphate and sodium acid pyrophosphate; c) sodium acid pyrophosphate and dicalcium phosphate dihydrate; d) sodium acid pyrophosphate, monocalcium phosphate, and calcium acid pyrophosphate; e) dicalcium phosphate dehydrate, monocalcium phosphate, and calcium acid pyrophosphate; f) sodium aluminum phosphate, sodium acid pyrophosphate, and dicalcium phosphate dihydrate; g) sodium aluminum sulfate and dicalcium phosphate dihydrate; and h) sodium aluminum sulfate and sodium acid pyrophosphate, the sodium acid pyrophosphate exhibiting an evolved percentage of carbon dioxide of about 30 or less at room temperature prior to baking, and the slower reacting of the leavening acids in the combination being at least 10 wt % of the total weight of the acid combination.

In the present invention, the more delayed or attenuated leavening profile is obtained by employing a leavening system having any of the following eight combinations of leavening acids: a) sodium aluminum phosphate and dicalcium phosphate dihydrate; b) sodium aluminum phosphate and sodium acid pyrophosphate; c) sodium acid pyrophosphate and dicalcium phosphate dihydrate; d) sodium acid pyrophosphate, monocalcium phosphate, and calcium acid pyrophosphate; e) dicalcium phosphate dehydrate, monocalcium phosphate, and calcium acid pyrophosphate; f) sodium aluminum phosphate, sodium acid pyrophosphate, and dicalcium phosphate dihydrate; g) sodium aluminum sulfate and dicalcium phosphate dihydrate; and h) sodium aluminum sulfate and sodium acid pyrophosphate.

SALP is sodium aluminum phosphate. SAPP is sodium acid pyrophosphate and exhibits an evolved percentage of carbon dioxide of preferably about 30 or less, more preferably about 26 or less and most preferably about 20 or less at room temperature prior to baking (during mixing and forming). DCPD (dicalcium phosphate dihydrate) is a relatively slow-reacting acid and further has a relatively high reaction activation temperature. DCPD is the slowest reacting leavening acid. Among SALP, SAS and SAPP, relative reaction rates can vary and any can be the slower reacting acid. In any combination, the slower or slowest reacting of the acids comprises at least 10 wt %, preferably at least 15 wt %, more preferably about 15 wt % to about 50 wt % and most preferably about 15 wt % to about 40 wt % of the total weight of the acid combination. A preferred combination is SAPP and DCPD. A preferred leavening acid combination or blend has a neutralizing value of about 40 to 65.

The relatively slow reaction rate and/or higher activation temperature of the slower reacting acid, most typically SAPP and/or DCPD, ensure that additional carbon dioxide will be liberated later in the baking process. This additional carbon dioxide gives the dough an additional “kick” or “puff” that ensures the dough will maintain a sufficient degree of leavening just prior to setting. The dough is considered to have set when it has solidified sufficiently that it substantially maintains its shape and form after removal from the oven and is exposed to ambient temperature and pressure.

The presence of the faster-acting or fastest-acting leavening acid in the combination ensures that proper nucleation takes place in the dough. The presence of the faster-acting or fastest-acting leavening acid in the combination ensures that some degree of carbon dioxide generation will take place before baking and/or during the initial stages of baking. If only a fast acting acid is used, there is not enough available during the baking process to “puff” the flatbread.

SALP compounds useful in the present invention include Levair by Innophos Inc., LEV-N-LITE by ICL-PPLP, and BUDAL 2308, 2312, and 2315 by Budenheim. Useful SAPP compounds with the desired reaction profile include but are not limited to SAPP#4 by Innophos Inc., RD-1 by ICL-PPLP and SAPP 15 and SAPP 20 by Budenheim.

Any of the aforementioned combinations of leavening acids may be further combined with other leavening acid(s). The additional acid(s) may be an acid found in another combination or another known acid not found in any of the acid combinations. Additional acids not found in the combinations include monosodium phosphate (MSP), monocalcium phosphate (MCP), and organic acids such as citric acid and fumaric acid and encapsulated and/or coated versions thereof.

In another embodiment of the present invention, DCPD may be used as a leavening acid either alone or in combination with co-leavening acids in addition to those described above (SALP/DCPD, SALP/SAPP/DCPD and SAS/DCPD). Combinations with MSP, MCP and organic acids such as citric acid and fumaric acid and encapsulated and/or coated versions thereof are also possible. Preferably, the co-leavening acid is faster-acting than DCPD. Use concentration levels are the same as for the combinations described above. In preferred blends, the relative concentrations for DCPD and a faster-acting co-leavening agent is the same as for the combinations described above.

Additional teachings directed to leavening systems are described in Chemical Leavening Agents, Encyclopedia of Chemical Technology, 4.sup.th Ed., vol. 3, pp. 893-901 (1992), which is incorporated herein by reference.

The composition and method of the present invention can be used to make flour flatbreads. Flour is derived from a grain such as wheat. The flour used must have sufficient gluten content and quality to withstand processing and retain gas. Flour sold commercially for home use and for food product manufacturing typically is of sufficient content and quality with which to manufacture flatbreads. An example of a suitable flour is that having a protein content of about 9 wt % to about 14 wt % and more preferably about 9 wt % to about 12 wt % based upon flour weight.

The term “shortening” is used to describe any animal or vegetable based oils or fats added to the dough to facilitate lubrication and processability. Shortening is preferably derived from hydrogenated vegetable based oils or fats.

Salt may optionally be added to the flour to toughen and strengthen the dough. Salt can enhance product flavor and shelf stability and dough processability. Salt is typically employed at about 0.5 wt % to about 5 wt % and most typically about 1 wt % to about 3 wt %.

Dough is formed by first mixing the dry ingredients (flour, leavening agents, salt, etc) with shortening, then water. The shortening is typically about 2 to about 20 wt % and more typically about 6 to about 10 wt % based upon the flour weight. Water is typically about 40 to about 100 wt % and more typically about 50 to about 60 wt % based upon the flour weight and can be optimized by water absorption measurements using a farinograph to a 750 BU (Brabender Units) level. The complete leavening system (base plus acid) is typically 0.5 to about 8.0 wt %, more typically about 0.5 to about 5.0 wt %, still more typically about 0.5 to about 3 wt %, still yet more typically about 1 to about 3 wt %, and most typically about 1 to about 2 wt % based upon the flour weight.

The flatbreads are generally prepared by forming a dough, flattening the dough to form dough flats and baking the flats until they leaven and set. A number of manufacturing methods are employed commercially. The methods include pressing, die cutting and hand stretching.

The pressing method has the following steps: a) preparing the dough composition as described above, b) allowing the dough to relax, c) dividing and rounding the dough composition to form a plurality of discrete dough balls, d) allowing the dough balls to relax, e) pressing the relaxed dough balls under heat and pressure to form relatively thinner dough flats, and f) baking the dough flats to form the flatbreads.

After the dough is formed, the dough is proofed for a period of time sufficient to allow the dough time to hydrate and relax. Preferably, the dough is allowed to proof for about 5 minutes or more. Relaxation is important to achieving good end product physical properties. The dough is then divided and rounded to form a plurality of discrete dough balls. The balls may be any shape but preferably are substantially spherical. optionally, the dough may be maintained at an elevated temperature, i.e. about 75 degree F. to about 100 degree F. (about 23.9 degree C. to about 37.8 degree C.), during proofing.

After the dough has been divided and rounded into balls, it is allowed to rest again. The time of relaxation is preferably at least about 5 minutes, more preferably at least about 10 minutes and most preferably about 10 to about 30 minutes. optionally, the dough may be maintained at an elevated temperature, i.e. about 75 degree F. to about 100 degree F. (about 23.9 degree C. to about 37.8 degree C.), during relaxation.

The relaxed dough balls are then pressed under elevated heat and pressure between platens or other flat surfaces to form relatively thinner dough flats. Preferably, one platen is stationary and the other actuates. The temperature and pressure will vary depending on the size and shape of the balls, properties of the dough, and the desired thickness and/or diameter of the flats. Pressure applied to the balls preferably ranges from about 400 to about 1200 pounds per square inch (about 2758 to about 7585 kilopascals). Temperature of the platens preferably varies from about 350 degree F. to about 500 degree F. (about 177 degree C. to about 260 degree C.) and most preferably from about 350 degree F. to about 450 degree F. (about 177 degree C. to about 232 degree C.). The temperature of the dough balls just prior to pressing preferably ranges from about 75 degree F. to about 100 degree F. (about 23.9 degree C. to about 37.8 degree C.).

The dough flats are then baked (heated) at an elevated temperature or temperature profile to a setting point to form flatbreads. During baking, the dough flats leaven upon generation of carbon dioxide and expansion of gases. Baking temperatures preferably range from about 360 degree F. to about 500 degree F. (about 182 degree C. to about 260 degree C.). Baking times preferably range from about 10 seconds or more, more preferably about 30 to about 50 seconds and most preferably about 35 to 45 seconds. Baking may take place at a constant temperature or at different temperatures. Ovens may have a single temperature zone or tier or multiple temperature zones or tiers. Useful oven types include, but are not limited to, single tier and three-tier ovens. In a preferred method, baking takes place in a three-tiered oven.

After baking, the flatbreads are cooled and packaged for shipment to consumers. The flatbreads are preferably cooled to a temperature of about 30 degree C. or less. Cooling prevents flatbreads from sticking together and limits moisture condensation inside packaging.

The die cutting method has the following steps: a) preparing the dough composition as described above, b) allowing the dough to relax as described above, c) rolling the dough to form a sheet, d) cutting the dough to form discrete dough flats, e) baking (heating) the dough flats to form flatbreads as described above. The dough is typically rolled to sheet form by passing it between juxtapositioned rollers although any method for flattening dough known in the are such as pressing or use of a rolling pin over a stationary surface may be employed. The sheet may cut by any means known in the art such as with a die, cutout or raised surface.

The hand stretch method is similar to the pressing method except that relaxed dough balls are rolled to form relatively thinner dough flats rather than by pressing. Rolling of dough balls is carried as described above for the rolling of dough into a sheet. The periphery of the dough flats may optionally be modified by manipulation by hand or other mechanical contact. The dough flats are then baked (heated) to form flatbreads as described above.

Other commercial methods employ freezing steps. Relaxed dough balls are formed as described above and are frozen for storage and/or transport to restaurants and food service facilities. The frozen dough balls are allowed to thaw to machineable higher temperatures and then are pressed or rolled to form discrete dough flats, which are then baked (heated) to form flatbreads as described above.

Other teachings to methods for making flatbreads are also described in the publication Methods to Prepare and Evaluate Wheat Flatbreads, Cereal Foods Worlds, vol. 36, no. 3, pp. 315 to 322 (1991), which is incorporated herein by reference.

The methods of the present invention can afford flatbreads that have enhanced physical and product quality, such as better specific volume, product height and diameter, texture, cell structure, appearance, opacity, eating quality, pliability, rollability and the like.

The dough composition may optionally comprise other ingredients, such as preservatives, emulsifiers, vitamins, dough conditioners, enzymes, reducing agents, acidulants and antimicrobials. Such ingredients can improve dough machineability, flatbread appearance and shelf life.

If desired, corn-based additives or ingredients, such as corn meal or corn flour, can be added to wheat-based flour to make flatbreads.

The present invention is useful in dough compositions for other than flatbreads. The present invention is useful in dough compositions for focaccia, pita, naan and roti breads.

Unless otherwise indicated, percentages and parts are expressed in the following examples on a flour weight basis.

### EXAMPLES

Flatbreads were prepared in accordance with the present invention and compared to flatbreads leavened with a control baking powder.

The baking powders employed to make the flatbreads of the present invention were the following: SALP/DCPD (60/40); SALP/SAPP #4 (60/40) and SAPP #4/DCPD (60/40). The SALP employed was by Levair. The control baking powder employed was Regent 12xx/BP Pyro 20/80, which is MCP/SAPP. One control was at full leavening amount (based on 0.6% fwb sodium bicarbonate fine granular) flour weight basis (fwb). All four experimental products were tested at 20% reduction in leavening (i.e. 0.5% fwb SBC).

TABLE 1

| | Full | | | | |
|---|---|---|---|---|---|
| | leavening | 20% reduction in leavening | | | |
| | 100% | Control* | (60/40) | (60/40) | (60/40) |
| Ingre- | Control* | (MCP/ | SALP + | SALP + | SAPP #4 + |
| dient | (MCP/SAPP) | SAPP) | DCPD | SAPP #4 | DCPD |
| Flour | 1000 | 1000 | 1000 | 1000 | 1000 |
| Salt | 15 | 15 | 15 | 15 | 15 |
| SSL | 5 | 5 | 5 | 5 | 5 |
| Potas- | 4 | 4 | 4 | 4 | 4 |
| sium | | | | | |
| Sorbate | | | | | |
| Sodium | 5 | 5 | 5 | 5 | 5 |
| Pro- | | | | | |
| pionate | | | | | |
| Sodium | 6 | 5 | 5 | 5 | 5 |
| Bicar- | | | | | |
| bonate | | | | | |
| Leaven- | 1.63 | 1.36 | 4.1 | 3.38 | 5.32 |
| ing acid | | | | | |
| Leaven- | 6.52 | 5.43 | 2.73 | 2.25 | 3.55 |
| ing acid | | | | | |
| Coated | 3.5 | 3.5 | 3.5 | 3.5 | 3.5 |
| Fumaric | | | | | |
| Cys- | 0.03 | 0.03 | 0.03 | 0.03 | 0.03 |
| teine | | | | | |
| Short- | 60 | 60 | 60 | 60 | 60 |
| ening | | | | | |
| Water | 525 | 525 | 525 | 525 | 525 |

*Not an example of the present invention.

### Preparation of Wheat Flatbread Dough

The flour used was ConAgra Buccaneer Bakers Flour (malted and bleached). The moisture absorption for the flour as determined by farinograph was 53%. Tap water was used for all experiments.

A Hobart mixer was used for dough mixing. The mixing procedure was as follows: a) dry materials were mixed for 2 minutes at low speed using a paddle; b) shortening was then added and mixed continuously another 6 minutes; c) the mixer blade was changed to a hook type, and water was added and the dough mixed about 2 minutes at low speed until no dry flour could be seen; d) the dough was then mixed at medium speed about 2-4 minutes until a soft, cohesive, and pliable dough was obtained. After mixing, the dough was covered with plastic film and rested (relaxed) for 5 minutes at room temperature (21 degree C.).

The rested dough was manually pre-sheeted, mechanically pressed, divided into 36 dough pieces, and rounded into small dough balls for 35 seconds using a Dutchess dough divider and rounder. The dough balls were covered with plastic film and rested 10 minutes at room temperature (21 degree C.) before they were hot pressed and baked.

A pilot line including pressing platens, a three tier gas oven (model OP01004-07 Micro Combo W/Head), and a five-tier cooling conveyor (model OCC1208-03 by Lawrence Equipment) was used to prepare the flatbreads. Both top and bottom hot plate temperatures were set at 196 degree C. Press time was 0.8 seconds using a medium pressure setting. The oven temperature was set at 204 degree C., and the oven dwell time was 40 seconds.

Total flatbread cooling time at room temperature after baking and just before packaging was 20 minutes, i.e., 2 minutes on the cooling conveyer and 18 minutes on a table with each flatbread individually separated. Flatbreads were then stored in polyethylene bags at room temperature (21 degree C.) for 33 (or more) days. There were a maximum of 15 flatbreads per bag.

### Wheat Flatbread Dough Evaluation

The pliability of flatbread dough was subjectively evaluated during its manual pre-sheeting (after a 5-minute rest) on a 1-5 scale where 1=very stiff with poor extensibility; 2=stiff and poorly extensible; 3=fairly soft and extensible; 4=soft with good extensibility and elasticity; 5=soft and having an excellent balance between extensibility and elasticity. Dough softness was rated on a 1-5 scale as well with higher numbers (points) indicating softer dough characteristics.

Dough ball smoothness, after the 10-minute resting period, was rated using a 1-5 point scale. Higher numbers (points) indicate smoother dough balls (desirable).

### Wheat Flatbread Characterization

Ten (10) 1-day stored flatbreads were stacked and measured to determine the average flatbread thickness (mm) and weight (g) per piece. Baked flatbread diameters (cm) were measured at two diagonals on each of 10 flatbreads per sample, and the overall mean was calculated. A flatbread specific volume (cm.sup.3/g) index was accordingly calculated.

### Results

In the first set of experiments, 3 blends of phosphates were examined at 80% leavening and compared to a fully leavened control and 80% leavened control. The results are set forth in Table 2 and FIGS. 1 to 5.

TABLE 2

| | Control | Control | SALP/ | SALP/ | SAPP #4/ |
|---|---|---|---|---|---|
| Property | #1* | #2* | DCPD | SAPP #4 | DCPD |
| Leavening Level | 100% | 80% | 80% | 80% | 80% |
| Dough Smoothness | 3.8 | 3.8 | 4.0 | 4.0 | 4.0 |
| (1-5) | | | | | |
| Dough Softness | 4.0 | 4.0 | 4.2 | 4.2 | 4.2 |
| (1-5) | | | | | |
| Dough Pliability | 3.8 | 4.0 | 4.2 | 4.2 | 4.2 |
| (1-5) | | | | | |
| Tortilla Diameter | 16.5 | 16.8 | 17.2 | 17.3 | 16.9 |
| (cm) | | | | | |
| Tortilla Thickness | 3.5 | 3.2 | 3.4 | 3.7 | 3.9 |
| (mm) | | | | | |
| Tortilla Weight | 39.6 | 39.0 | 39.2 | 39.1 | 38.9 |
| (g) | | | | | |
| Specific Volume | 1.89 | 1.82 | 2.01 | 2.22 | 2.25 |
| (cm³/g) | | | | | |

*Not an example of the present invention

The three blends (SALP/DCPD, SALP/SAPP#4, SAPP#4/DCPD) exhibited better dough handling properties than the controls (both at 100% and 80% leavening). This demonstrated that it was possible to improve manufacturing processing parameters with a reduction in overall leavening.

All three leavening blends exhibited enhanced finished product properties improve over the control with 20% reduction in overall leavening. The highest thicknesses and specific volumes were obtained with SALP/SAPP #4 and SAPP#4/DCDP.

We claim:

1. A flat bread dough composition, comprising: A) flour; B) shortening; C) water; and D) a leavening system having a leavening base and a leavening acid having a combination selected from the group consisting of a) sodium aluminum phosphate and dicalcium phosphate dihydrate; b) sodium aluminum phosphate and sodium acid pyrophosphate; c) sodium acid pyrophosphate and dicalcium phosphate dihydrate; d) sodium acid pyrophosphate, monocalcium phosphate, and calcium acid pyrophosphate; e) dicalcium phosphate dehydrate, monocalcium phosphate, and calcium acid pyrophosphate; f) sodium aluminum phosphate, sodium acid pyrophosphate, and dicalcium phosphate dihydrate; g) sodium aluminum sulfate and dicalcium phosphate dihydrate; and h) sodium aluminum sulfate and sodium acid pyrophosphate, the sodium acid pyrophosphate exhibiting an evolved percentage of carbon dioxide of about 30 or less at room temperature prior to baking, and the slower reacting of the leavening acids in the combination being at least 10 wt % of the total weight of the acid combination.

2. The composition of claim 1, wherein the slower reacting of the leavening acids in the combination is at least 15 wt % of the total weight of the acid combination.

3. The composition of claim 1, wherein the slower reacting of the leavening acids in the combination is about 15 wt % to about 50 wt % of the total weight of the acid combination.

4. The composition of claim 1, wherein the leavening acid has a neutralizing value of about 40 to about 65.

5. The composition of claim 1, wherein the sodium acid pyrophosphate exhibits an evolved percentage of carbon dioxide of about 30 or less at room temperature prior to baking.

6. The composition of claim 1, wherein the leavening system is present from about 0.5 wt % to about 8 wt % based upon the weight of the flour.

7. The composition of claim 1, wherein the leavening system is present from about 0.5 wt % to about 5 wt % based upon the weight of the flour.

8. The composition of claim 1, wherein the leavening system is present from about 1 wt % to about 3 wt % based upon the weight of the flour.

9. The composition of claim 1, wherein the leavening acid combination is sodium aluminum phosphate and dicalcium phosphate dehydrate.

10. The composition of claim 1, wherein the leavening acid combination is sodium aluminum phosphate and sodium acid pyrophosphate.

11. The composition of claim 1, wherein the leavening acid combination is sodium acid pyrophosphate and dicalcium phosphate dihydrate.

12. The composition of claim 1, wherein the leavening acid combination is sodium aluminum phosphate, sodium acid pyrophosphate, and dicalcium phosphate dihydrate.

13. The composition of claim 1, wherein the leavening acid combination is sodium aluminum sulfate and dicalcium phosphate dihydrate.

14. The composition of claim 1, wherein the leavening acid combination is sodium aluminum sulfate and sodium acid pyrophosphate.

15. The composition of claim 1, wherein the dough composition is a flatbread dough composition.

16. The composition of claim 1, wherein the dough composition is selected from the group consisting of a tortilla dough composition, a focaccia dough composition, a pita dough composition, a naan dough composition and a roti dough composition.

17. The composition of claim 1, wherein the composition is frozen.

18. A method for making flatbreads, comprising: A) providing a dough composition according to claim 1; B) allowing the dough to relax; C) dividing and rounding the dough composition to form a plurality of discrete dough balls; D) allowing the dough balls to relax; E) pressing the relaxed dough balls under heat and pressure to form relatively thinner dough flats; F) heating the dough flats to form the flatbreads.

19. The method of claim 18, wherein the dough balls are allowed to relax for at least about 5 minutes.

20. The method of claim 18, wherein the dough balls are allowed to relax for at least about 10 minutes.

21. The method of claim 18, wherein the dough balls are allowed to relax for about 10 to about 30 minutes.

22. The method of claim 18, wherein the relaxed dough balls are pressed between platens at about 400 to about 1200 pounds per square inch.

23. The method of claim 18, wherein the relaxed dough balls are pressed between platens, and wherein the platens are maintained at a temperature of about 350 degree F. to about 500 degree F.

24. The method of claim 18, wherein the relaxed dough balls are at a temperature of about 75 degree F. to about 100 degree F. just prior to pressing.

25. The method of claim 18, wherein the dough flats are baked for about 10 seconds or more.

26. The method of claim 18, wherein the dough flats are heated to a temperature of about 360 degree F. to about 500 degree F. for about 30 to about 50 seconds.

27. The method of claim 18, wherein the dough flats are heated for about 35 to about 45 seconds.

28. The method of claim 18, wherein the slower reacting of the leavening acids in the combination is about 15 wt % to about 50 wt % of the total weight of the acid combination.

29. The method of claim 18, wherein the leavening acid combination has a neutralizing value of about 40 to about 65.

30. The method of claim 18, wherein the sodium acid pyrophosphate exhibits an evolved percentage of carbon dioxide of about 30 or less at room temperature prior to baking.

31. The method of claim 18, wherein the leavening system is present from about 0.5 wt % to about 8 wt % based upon the weight of the flour.

32. The method of claim 18, wherein the leavening system is present from about 0.5 wt % to about 5 wt % based upon the weight of the flour.

33. The method of claim 18, wherein the leavening system is present from about 1 wt % to about 3 wt % based upon the weight of the flour.

34. The method of claim 18, wherein the leavening acid combination is selected from the group consisting of a) sodium aluminum phosphate and dicalcium phosphate dihydrate; b) sodium aluminum phosphate and sodium acid pyrophosphate; c) sodium acid pyrophosphate and dicalcium phosphate dihydrate; d) sodium acid pyrophosphate, monocalcium phosphate, and calcium acid pyrophosphate; e) dicalcium phosphate dehydrate, monocalcium phosphate, and calcium acid pyrophosphate; f) sodium aluminum phosphate, sodium acid pyrophosphate, and dicalcium phosphate dihydrate; g) sodium aluminum sulfate and dicalcium phosphate dihydrate; and h) sodium aluminum sulfate and sodium acid pyrophosphate.

35. A method for making flatbreads, comprising: a) providing a dough composition according to claim 1; b) allowing the dough composition to relax; c) flattening the relaxed dough composition to form relatively thinner dough flats; and d) baking the dough flats to form the flatbreads.

36. The method of claim 35, wherein the relaxed dough composition is divided and rounded to form a plurality of discrete dough balls, wherein the dough balls are frozen, wherein the dough balls are allowed to thaw to a machineable higher temperature, and wherein the dough balls are flattened to form the dough flats.

37. A method for making flatbreads, comprising: A) providing a dough composition according to claim 1; B) allowing the dough composition to relax; C) rolling the dough to form a sheet; D) cutting the dough to form discrete dough flats, and E) baking the dough flats to form the flatbreads.

38. A method for making flatbreads, comprising: a) providing a dough composition according to claim 1; b) allowing the dough composition to relax; C) dividing and rounding the dough composition to form a plurality of discrete dough balls; d) allowing the dough balls to relax; e) rolling the relaxed dough balls to form relatively thinner dough flats; f) reshaping the periphery of the dough flats; and g) baking the reshaped dough flats to form the flatbreads.

39. A flatbread dough composition, comprising: a) flour b) shortening c) water d) a leavening system having a leavening base and a leavening acid having dicalcium diphosphate

40. The composition of claim 39, wherein the leavening acid further has a co-leavening acid that is faster-acting than dicalcium diphosphate.

41. A method for making flatbreads, comprising: a) providing a dough composition according to claim 39; b) allowing the dough composition to relax; c) flattening the relaxed dough composition to form relatively thinner dough flats; and d) baking the dough flats to form the flatbreads.
